(19) United States
(12) Patent Application Publication
(10) Pub. No.: US 2005/0249227 A1
(43) Pub. Date: Nov. 10, 2005

(54) Method for indicating buffer status in a WLAN access point

(76) Inventors: Huai Y. Wang, Coconut Creek, FL (US); Ye Chen, Schaumburg, IL (US); Stephen P. Emeott, Rolling Meadows, IL (US); Floyd D. Simpson, Lake Worth, FL (US)

Correspondence Address: Scott M. Garrett;Motorola, Inc., Law Department, 8000 West Sunrise Boulevard, Fort Lauderdale, FL, 33322, US

(21) Appl. No.: 10/841,778

(22) Filed: May 7, 2004

(51) Int. Cl. H04B 7/212

(52) U.S. Cl. 370/412; 370/338

(57) ABSTRACT

A wireless local area network (WLAN) includes an access point (102) and a mobile station (106). The mobile station can operate in a low power mode by shutting down a WLAN subsystem (204) of the mobile station. While the mobile station is in a low power mode, the access point buffers data received at the access point destined for the mobile station (706). The mobile station wakes up to initiate a service period by transmitting a trigger frame to the access point, and identifies a traffic stream to be serviced in the presently initiated service period. The access point begins transmitting response frames to the mobile station, identifying the traffic stream requested by the mobile station, and in at least one response frame, the access point may indicate the buffer status of another traffic stream associated with the mobile station to allow the mobile station to make decisions regarding data retrieval and power save state.

### TECHNICAL FIELD

This invention relates in general to wireless local area networks, and more particularly to power save methods for reducing power consumption at a mobile station while engaged in a time sensitive communication activity.

### BACKGROUND OF THE INVENTION

Wireless LAN (WLAN) systems providing broadband wireless access have experienced a spectacular rise in popularity in recent years. While the principal application of these systems has been in providing network connectivity to portable and mobile devices running data applications such as, for example, email and web browsing, there has been a tremendous and growing interest in supporting isochronous services such as telephony service and streaming video.

One of the key issues facing wireless system designers when considering voice and other time-sensitive services over a WLAN connection, such as one described by the IEEE 802.11 specification, is the power consumption of handheld devices. For example, in order to deliver competitive talk time and standby time, as compared to digital cordless or cellular devices, power conservation during voice calls become necessary. Several organizations have proposed power-efficient operation via transmit power control and physical layer rate adaptation for systems that rely on a centrally controlled contention-free channel access scheme. However, such approaches can be complex to implement and may not provide the power savings required to justify the complexity.

The 802.11 standard defines procedures which can be used to implement power management in a handheld device during periods of inactivity. The hand held devices are referred to as mobile stations, which mean non-access point WLAN stations. In particular, three distinct building blocks are provided to support power savings: a Wakeup Procedure, a Sleep Procedure, and a Power-save Poll (PS-Poll) Procedure. A mobile client voice station (mobile station) can combine these building blocks in various manners to support power management for different applications. Other techniques have recently been developed as well, such as the use of a trigger frame to initiate a service period where the access point releases all data presently stored and transmits it to the mobile station that has initiated the service period. Some mechanisms are in place today to provide mobile stations a lump-sum indication of all traffic streams associated with a mobile station that an access point has buffered for the mobile station. However, none of these power saving schemes inform the mobile station of the type and/or priority of the traffic streams buffered at the access point while the mobile station is using a low power mode. Therefore, there is a need for scheme by which the access point can inform a mobile station operating in a power save mode of the status of a buffer maintained by the access point for the mobile station.

### BRIEF DESCRIPTION OF THE DRAWINGS

FIG. 1 shows a block system diagram overview of a typical enterprise WLAN system that may support both prior art methods of WLAN transactions as well as those in accordance with the present invention;

FIG. 2 shows a schematic block diagram of a mobile station for use in a WLAN system, in accordance with the invention;

FIG. 3 shows a schematic block diagram of an access point for use in a WLAN system, in accordance with the invention;

FIG. 4 shows a flow diagram illustrating an overview of the traffic flow between a mobile station and an access point in a WLAN system in accordance with one embodiment of the present invention;

FIG. 5 shows a frame header diagram of the information transmitted in the header of a response frame, in accordance with one embodiment of the invention;

FIG. 6 shows a first mapping of field entries and their meanings, for use with the invention; and

FIG. 7 is a flowchart diagram of a method for indicating the buffer status of an access point in a WLAN quality of service system.

### DETAILED DESCRIPTION OF A PREFERRED EMBODIMENT

While the specification concludes with claims defining the features of the invention that are regarded as novel, it is believed that the invention will be better understood from a consideration of the following description in conjunction with the drawing figures, in which like reference numerals are carried forward. The invention enables a wireless loacal area network (WLAN) access point to inform a mobile station operating according to a low power mode of operation of the buffer status of any traffic streams associated with the mobile station by using information in the header of quality of service (QoS) frames sent to the mobile station while servicing a traffic stream.

Referring now to FIG. 1, there is shown a block system diagram overview 100 of a typical enterprise WLAN system. It includes an infrastructure access network 101, consisting of an Access Point 102 and mobile stations such as a data stations 104 and a voice station 106. The mobile stations are connected to the access point via a WLAN radio link 108. The access point is wired to a distribution network, including voice and data gateways 110, 112 respectively, through a switch 114. The voice station runs a Voice-over-IP (VoIP) application, which establishes a peer-to-peer connection with the voice gateway, representing the other end of the voice call, and which routes voice data to a voice network 116. Data stations may connect to the data gateway via the access network and connect to, for example, a wide area network 118. The impact of data traffic on voice quality should be considered. It is assumed that both the voice and data stations employ a prioritized contention-based quality of service (QoS) mechanism where the QoS parameters are negotiated prior to engaging in a call to assure the necessary communication resources will be available to support the call. Reservation of resources is necessary because of the time-sensitive nature of voice and other communications. In the call set up process, a traffic stream identifier (TID) is assigned to the call, and used with all data packets in the traffic stream between the mobile station and access point. When a mobile station is in power save mode, the access point buffers data received from the switch for the mobile station until the mobile station requests the data. In voice communications, the mobile station will wake up periodically to request data from the access point for the voice stream, using the TID associated with the call while the mobile station is operating in power save mode. In addition, the mobile station may engage in additional data sessions while engaging in voice communication, such as, for example, video packet data, and so on. There are four categories of data defined by the IEEE 802.11e draft standard, presently, which are voice, video, best effort, and background. In addition, each access category has two levels of user priority (UP). The access point periodically broadcasts a beacon frame, and in the beacon frame identifies mobile stations presently affiliated with the access point in a traffic indication map, which indicates the presence of buffered data at the access point for the mobile station. However, only one bit is used per mobile station, so the mobile station will only be informed that data is present, but not the type of data, how much data, or the priority of the data. If the data present is background data, or of an otherwise low priority, it may be desirable for the mobile station to not retrieve the data, and instead remain in power save mode. Alternatively, the mobile station may transition out of power save mode to active mode, informing the access point of the transition, to receive continuous delivery from the access point when the mobile station decides there is a sufficiently large quantity of data buffered at the access point. After transitioning to the active mode and receiving and receiving data from the access point to deplete the buffer, the mobile station may then transition back to power save operation, informing the access point of the transition while doing so.

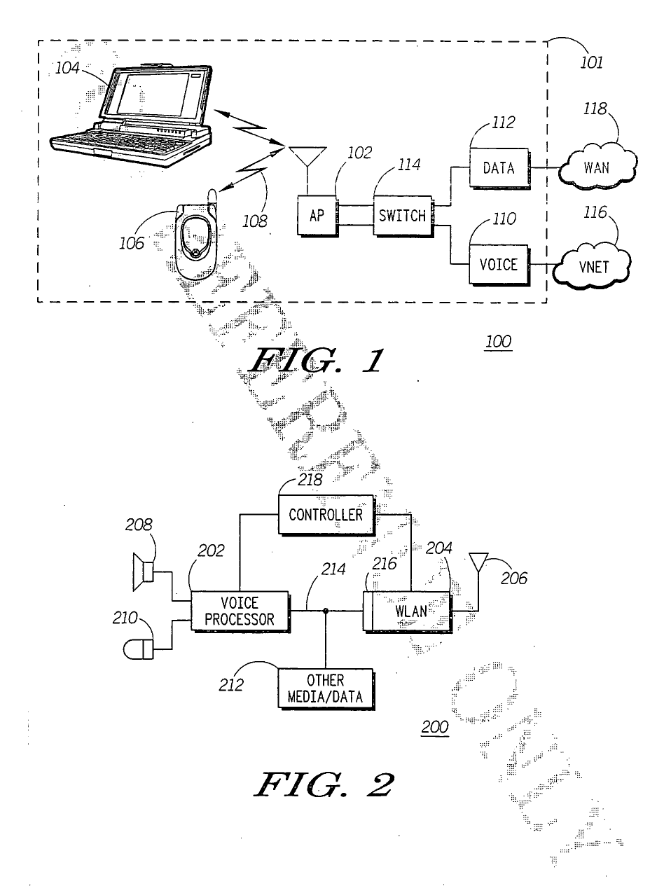

Referring now to FIG. 2, there is shown a schematic block diagram 200 of a mobile station for use in a WLAN system, in accordance with the invention. The mobile station comprises a voice processor 202 for processing voice signals, including transforming signals between digital and analog form. The voice processor is operably coupled to a WLAN subsystem 204. The WLAN subsystem contains data buffers and radio hardware to send and receive information over a wireless radio frequency link via an antenna 206. The voice processor converts digital voice and audio data received from the WLAN subsystem to analog form and plays it over a transducer, such as a speaker 208. The voice processor also receives analog voice and audio signals from a microphone 210, and converts them to digital signals, which are sent to the WLAN subsystem. Preferably the voice processor also performs voice encoding and decoding, by using, for example, vector sum excited linear predictive coding techniques, as is known in the art. The use of voice encoding allows for compression of the voice data. In addition to voice processing, the mobile station may have other media processors, abstracted as box 212, which may included regular data applications such as email, for example. These other data processors are likewise operably coupled to the WLAN subsystem via bus 214, for example. As data arrives at the WLAN subsystem, it gets buffered in a WLAN buffer 216 and subsequently packetized for transport over IP networks. Each processor sending data to the WLAN subsystem indicates the type of data, and formats the data for transmission, indicating the type of data in the frame. All data processors and the WLAN subsystem are controlled by a controller 218. The controller dictates the power save operation of the WLAN subsystem, setting it into lower power states when appropriate and powering it up when it is time to transmit or receive data. In one embodiment of the invention, it is contemplated that the WLAN capabilities and elements shown here are incorporated into a communication device capable of also engaging in communication over conventional cellular networks.

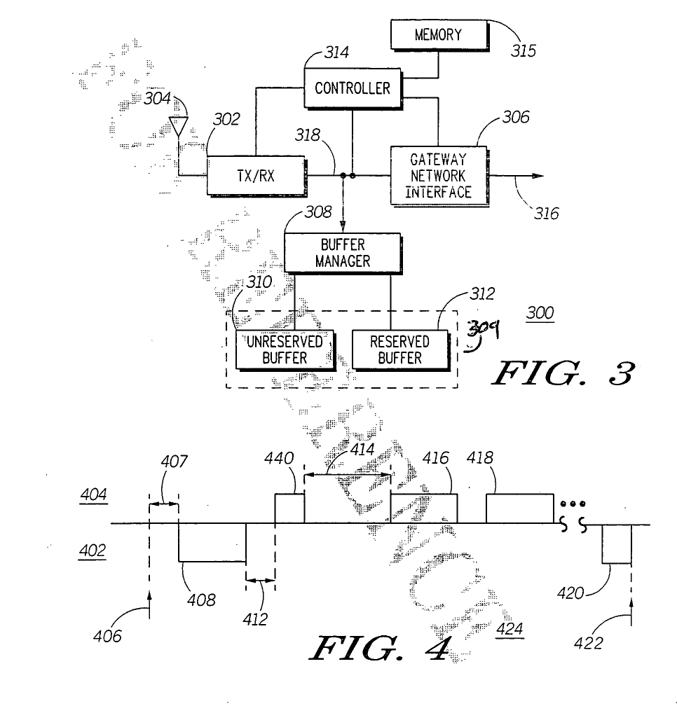

Referring now to FIG. 3, there is shown a schematic block diagram 300 of an access point for use in a WLAN system, in accordance with the invention. A WLAN transceiver 302 performs the radio frequency operations necessary for communicating with mobile stations in the vicinity of the access point via an antenna 304. The access point is connected to networks via gateway network interface 306, typically via a hard line 316, such as a coaxial cable, for example. Data received at the access point from mobile stations is immediately forwarded to the gateway for routing to the appropriate network entity. Data received at the access point from the network that is bound for a mobile station may be treated according to one of at least three classifications. First, the mobile station may be in active mode, in which case the data will be buffered only until it can be transmitted. In such a case the intent is to not delay transmission to the mobile station any longer than necessary, and data for a mobile station of this classification is typically transmitted using a priority-based queuing discipline. A second category of mobile station power save state is a mobile station in an unreserved or legacy power save mode. For this second classification, a buffer manager 308 buffers the data in an unreserved data buffer 310 upon receiving it from the gateway 306 via a bus 318. Unreserved data is data that does not belong to a reserved traffic stream or QoS stream. Of the four access categories (AC) presently defined by IEEE 802.11e, the best effort and background access categories are generally considered as unreserved data. When the particular mobile station for which the unreserved data is buffered transmits to the access point either a power save (PS) poll frame or a frame that transitions the mobile station to the active state, the access point will respond by transmitting the unreserved data to the polling station from the unreserved data buffer. The manner of delivery may be controlled by the mobile station, where the unreserved data is only delivered in response to a specific polling or trigger frame, or it may be delivered at regularly scheduled and agreed upon time intervals. A third power save classification the access point may receive data for is reserved data bound for a mobile station using a mobile station initiated service period in accordance with power save mode. Reserved data is data that belongs to a reserved traffic stream, such as voice or video data. For this reserved flow data, the buffer manager 308 buffers the data in a reserved buffer 312. By reserved buffer it is meant that the buffer is for buffering data belonging to a reserved traffic stream. Although illustrated here as two separate physical buffers, one skilled in the art will understand that a variety of buffering techniques may be used to keep reserved and unreserved data separate, without necessarily requiring separate physical buffers. Furthermore, given that the access point may respond to a polling frame with an aggregate response, the unreserved data buffer and reserved buffer may be treated as an aggregate buffer 309.

Since the data associated with the reserved traffic stream is, by convention, time sensitive, and therefore of a high priority, the access point preferably maintains an aging policy. Supervising the operation of the buffer manager 308, gateway 306, and transceiver 302 is a controller 314. The controller also administers resource management and controls resources so that quality of service may be assured as needed for reserved traffic streams. The controller is operably coupled to a memory 315, which it uses to track the status of call, mobile station power save states, and other parameters.

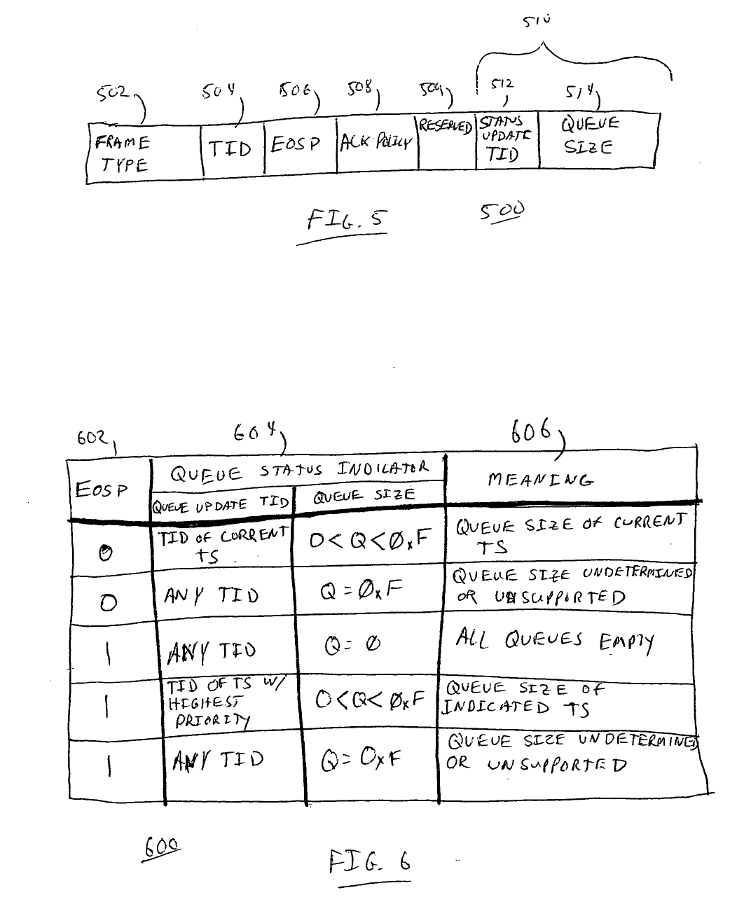

According to the invention, the mobile station determines which data it will receive from the access point by transmitting a trigger frame to the access point, specifying the traffic stream for which the mobile station desires to receive data, as shown in FIG. 4. Referring now to FIG. 4, there is shown a flow diagram 400 illustrating an overview of the traffic flow between a mobile station and an access point in a WLAN system using the present invention. The traffic flow includes a reserved traffic stream, meaning that the mobile station and access point have negotiated a priority and medium time for the reserved traffic stream to ensure a desired quality of communication, where the medium time indicates the amount of time per negotiated service interval the access point will apportion to the traffic stream or access category. With voice traffic, since it occurs in real time, it is desirable to establish a reserved traffic stream for the communication. The system carrying out the flow shown here in FIG. 4 may be performed by a system using configurations and system components similar to those shown in FIGS. 1-3 with control software designed in accordance with the teachings herein.

The mobile station transmissions appear on the bottom flow line 402, while the access point transmissions appear on the top flow line 404. It is assumed that the access point receives the mobile station transmissions, and vice-versa. As mentioned, prior to the transaction illustrated here, the mobile station and access point will have established a reserved traffic stream, meaning the access point has reserved certain resources to maintain voice quality of the traffic stream. That is, the access point will be able to service the flow in a timely manner so that the real-time effect of the flow is maintained. To prevent an overloaded scenario in a WLAN voice system, where an excessive number of high priority users might make it difficult for a system to satisfy quality of service requirements, admission control should be required for certain services, such as real-time voice and video streaming. For example, in an infrastructure based voice WLAN system, a mobile station (e.g. voice user) should set up a bi-directional traffic flow for voice using a known traffic specification, and the access point should acknowledge the admission of the flow to the mobile station. By admitting the flow, it is meant that the data flow will be a reserved traffic stream having a unique traffic stream identifier. The reserved traffic stream will have a priority classification and will be apportioned a minimum amount of channel access time. During the connection setup period, the use of a power save mechanism can be established by mobile station implicitly by the use of a traffic specification reservation. In frames containing data for the reserved traffic stream, the unique traffic stream identifier (TSID) will be included. The mobile station can choose no power save operation, legacy power save operation, or trigger-initiated power save operation as shown here. After the traffic flow is admitted by the access point, the mobile station puts the WLAN subsystem in a low power mode.

After the WLAN subsystem is placed in low power mode, the mobile station preferably maintains a service interval timer to maintain real time operation of the flow. At the beginning of a service interval, the mobile station activates the WLAN subsystem, such as at time 406, by powering up the WLAN subsytem. After which, during the time period 407, the mobile station begins contending for the WLAN channel. The mobile station initiates the exchange by transmitting a trigger frame 408. The trigger frame may be a voice frame, which in the preferred embodiment contains a unique traffic stream identifier, and a frame of voice data if the user of the mobile station is presently speaking, or if there is no voice data to transmit presently, the trigger frame will be a null frame. The trigger frame will identify the reserved traffic stream and indicate the mobile station is using a power save mode. The trigger frame also indicates to the access point that the mobile station is ready to receive the data the access point has buffered for the mobile station associated with the traffic stream identified in the trigger frame.

After the access point receives the trigger frame, it transmits an acknowledgement 410 within a short interframe space time period 412, which is a scheduled event, in accordance with the IEEE 802.11 specification. In response to receiving the trigger frame, the access point transmits at least one response frame 416 to the mobile station, assuming the access point has buffered data for the mobile station. If the access point has more than one frame of data to transmit, a second response frame 418 will be transmitted. The access point will continue to transmit response frames until the buffer is empty, or, alternatively, upon the expiration of a service period time. In one embodiment of the invention, each response frame includes and end of service period bit that is either set or clear to indicate if the present response frame is the final frame the access point will transmit in the present service period. According to the invention, the access point also includes in the header of each response frame a queue status field indicating the queue size of a traffic stream associated with the mobile station identified by the TID for that traffic stream. That is, the queue status field is used to inform the mobile station as to the buffer status, meaning the amount of data buffered, of a traffic stream associated with the mobile station, which may be the traffic stream presently being serviced, or a different traffic stream associated with the mobile station. This information may be used by the mobile station in making data retrieval decisions or power save state transitions. In one embodiment the queue status is only used in the final response frame, but it is contemplated that, if more than one additional traffic stream is being used by the mobile station, a buffer's status may be indicated in each response frame, and in each subsequent response frame a different traffic stream buffer status may be indicated.

The time period between receiving the polling frame and transmitting the response frame can vary as the access point may have to finish attending to another flow for another mobile station. In the preferred embodiment, there will typically be a turnaround interframe space time period 414 between the acknowledgement and the response frame. As soon as possible, the access point will acquire the WLAN channel and transmit the response frame or frames. However, the response frame is not sent with regard to any predetermined schedule. That is, mobile station stays active to receive the response frame for an indeterminate period of time. Of course, a reasonable maximum period of time could be observed to prevent the mobile station waiting too long for a response frame or remaining active too long. In the event the maximum period occurs, the mobile station can take appropriate action, such as polling the access point a second time during the service period to check the status of the buffer or buffers and retrieve any frames waiting to be transmitted. If the access point has data in the reserved buffer associated with the reserved traffic stream, the access point will transmit a frame of data from the buffer. If there is no data buffered, the access point will transmit a null frame, and indicate the end of the service period. Alternatively, if the buffer is empty, then the acknowledgement 410 may indicate such. In the response frame there will be signaling information, such as an EOSP bit designated to indicate the end of the present service period, which may occur because there is no more data to transmit or because a maximum service period time has been reached. In response to receiving the response frame, in the preferred embodiment, the mobile station transmits an acknowledgement 420 within a short interframe space time period 418. If the response frame indicated the end of the present service period, the mobile station then places the WLAN subsystem into a low power state after receiving the response frame at time 422. If the response frame indicated the access point has buffered data for other traffic streams associated with the mobile station, the mobile station can use that information to make data retrieval power save state transition decisions based on the priority, quantity, and type of data held in the other buffer or buffers.

Referring now to FIG. 5, there is shown a QoS control subfield diagram 500 in the header of a response frame, in accordance with one embodiment of the invention. The queue status information is transmitted in the QoS control subfield of QoS Data, QoS Null, QoS CF-ACK, and QoS Data+ACK frames sent by an access point. The “QoS” designation indicates the frame is in QoS frame format and may belong to a quality of service traffic stream, also referred to as a reserved traffic stream. The “Data” designation indicates the frame is a data type frame carrying payload, such as voice data received from the user of the mobile station while talking into the mobile station during a call. The “Null” designation indicates the frame is a data type frame but carries no payload data, and the “ACK” designation indicates the frame piggybacks acknowledgement to a frame sent by another WLAN entity. The TID 504 is the traffic stream identifier selected at call set-up to identify the traffic stream and is typically 4 bits wide. The end of service period (EOSP) 506 bit indicates if the present frame is the last frame to be transmitted by the access point in the present service period. The ACK POLICY field 508 determines the type of acknowledgement expected in reply to the response frame. A bit is reserved 509 for future use. The queue status indicator field 510 includes two subfields; a status update TID field 512 and a queue size field 514. The status update TID field carries the traffic stream identifier of the traffic stream for which the queue status is reported in the queue size field 514. It may be the same traffic stream identifier in the TID field 504, or a different TID may be indicated. The queue size field 514 will show the amount of data, preferably in octets, buffered for the traffic stream having the TID in the status update TID field 512.

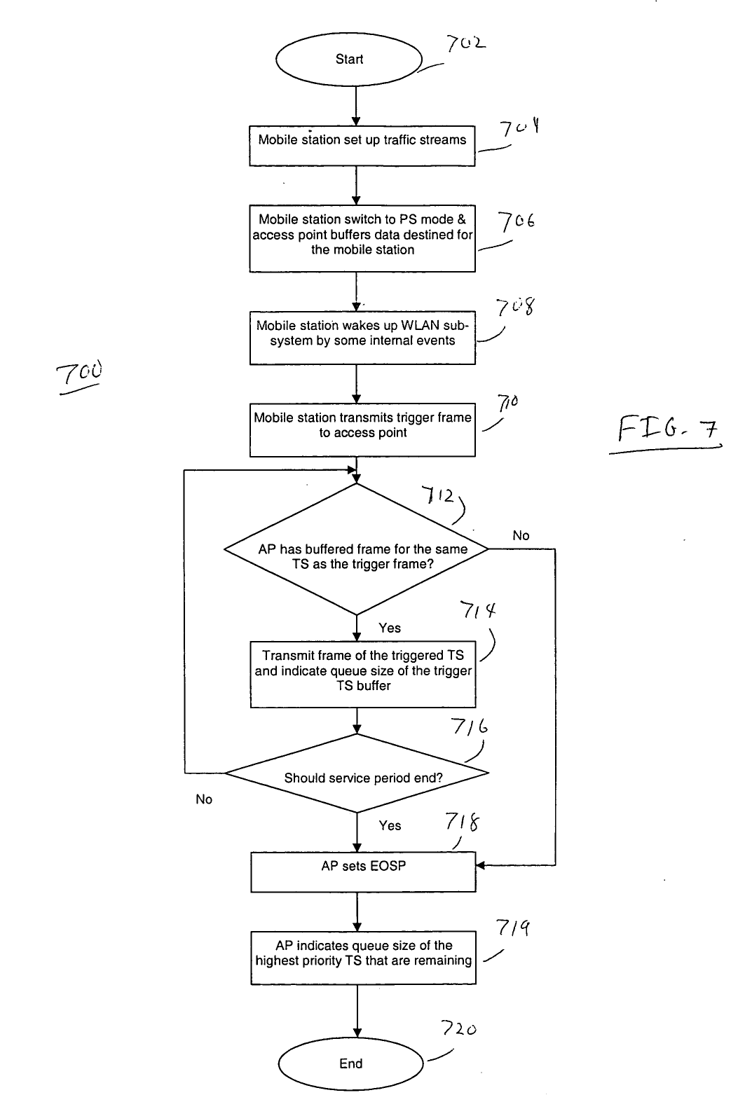

Referring now to FIG. 6, which shows a first mapping 600 of field entries and their meanings, for use with the invention. As shown in FIG. 5, the frame header of the response frame sent by the access point includes an end of service period (EOSP) bit 506 and a queue status indicator field 510. In the mapping of FIG. 6, the EOSP bit state column 602 is combined with the queue status indicator field columns 604 to provide an interpretation or meaning 606. If the EOSP bit is clear, as indicated, for example, by a logical “0,” it indicates the present response frame is not the last response frame to be sent by the access point during the service period. Accordingly the queue update TID subfield will simply contain the TID of the present traffic stream being serviced by the response frame. The queue size field will indicate the amount of data left in the buffer at the access point, and will be between 0 and a maximum number, such as, for example, 65535. The access point sets the queue size field to 65535 in case the queue status indicator is undetermined or unsupported. If the EOSP bit is set, such as, for example with a logical “1,” then the present response frame is the last frame of data to be transmitted by the access point for the present service period. There are three possible combination identified here. First, if the queue size is set to zero, then any TID can be placed in the queue update field, and it will be known that there is no data in any buffers, or alternatively that there is no other traffic stream to be serviced. Alternatively, the TID may be the TID of any remaining traffic stream associated with the mobile station. If there is more than one remaining traffic stream associated with the mobile station, the access point may use any algorithm in selecting the traffic stream to report in the queue status indicator field 604. In the preferred embodiment, the access point selects the highest priority traffic stream among those remaining in the queue status indicator field 604. When the TID indicated in the queue status TID field is identical to the being serviced in the present response frame, the access point is informing the mobile station that the present service period is ending due to time constraint, and that there is still data for the traffic stream remaining in the buffer. When a valid TID for a traffic stream associated with the mobile station other than the one being serviced by the present response frame is indicated in the queue status TID field, the access point is informing the mobile station of the buffer status of the selected traffic stream. In both cases the access point will indicate the amount of data in the buffer in the queue size field with a number between zero and a maximum buffer size. Finally, the queue size field may be set to a maximum number to indicate the buffer status of another traffic stream is undetermined, or the feature is unsupported by the access point.

Referring now to FIG. 7, there is shown a flow chart diagram 700 of a method for indicating buffer status, in accordance with one embodiment of the invention. At the start (702) the mobile station is powered up and is associated with a WLAN access point. First, one or more traffic streams are established (704). The call parameters are negotiated to assure proper quality of service. Typically then, the mobile station places the WLAN subsystem into a low power mode (706), indicates the power save state transition to the access point, and the access point begins buffering data it receives that is destined for the mobile station. When the time comes to transact information, the mobile station wakes up the WLAN subsystem (708). Subsequently, the mobile station transmits a trigger frame to the access point (710). The access point, in response to receiving the trigger frame, reads the TID in the trigger frame, locates the appropriate buffer, and determines if there is any data to transmit (712). If there is buffered data destined for the mobile station, the access point prepares to transmit a response frame for the traffic stream identified in the trigger frame received from the mobile station (714). Next, the access point determines if the service period should end, either because of time constraints, or because of a lack of data buffered at the access point for the traffic stream identified in the trigger frame received from the mobile station (716). If the service period is not ending, the frame is transmitted, and then the process repeats determining if there is data (712), preparing to transmit the data (714), and determining if the end of the service period has arrived (716). If the service period is terminating, or if there was no data found to be buffered in 712, then a frame is prepared with the EOSP bit set (718), and then the access point transmits the frame, indicating the queue size of the highest priority traffic stream remaining at the access point associated with the mobile station.

Therefore the invention provides a method for indicating a buffer status of a buffer reserved for a mobile station at an access point, and comprises receiving, at the access point from the mobile station, a trigger frame. The trigger frame initiates a present service period and includes a first traffic stream identifier associated with the present traffic stream, which is a first traffic stream. The present service period is initiated for transmitting data of the first traffic stream buffered at the access point to the mobile station. In response to receiving the trigger frame from the mobile station, the access point commences transmitting a response frame including the first traffic stream identifier. The response frame also includes a second traffic stream identifier of a second traffic stream associated with the mobile station, and includes the buffer status of the second traffic stream. It is contemplated that transmitting the response frame may include indicating the present size of the buffer of the second traffic stream. It is further contemplated that the response frame is an End Of Service Period frame indicating the buffer of the first traffic stream is now empty, after transmitting the End Of Service Period frame. If no data is presently buffered for the first traffic stream, the access point may transmit a response frame indicating a null frame type while indicating the buffer status of other traffic streams. Accordingly the access point may transmit at least one data frame for the first traffic stream if there is data buffered at the access point for the first traffic stream. The traffic stream may be a voice stream, although it is contemplated that packet data streams may use the invention equivalently. It is further contemplated that the response frame, in addition to indicating the TID of another stream, may be used to indicate a priority of the other traffic stream.

The invention also provides for a method for transacting data in a wireless local area network (WLAN) between an access point and a mobile station associated with the access point, which commences by establishing a first traffic stream and a second traffic stream at the access point for the mobile station, then placing the mobile station in a power save state, including indicating to the access point that the mobile station is in the power save state. In response the access point will begin buffering data received at the access point destined for the mobile station. When the time comes to initiate a service period, the mobile station commences waking up, meaning the WLAN subsystem of the mobile station is power up to access the WLAN medium. After waking up the mobile station, the mobile station commences transmitting a trigger frame to the access point, including a first traffic stream identifier which identifies the first traffic stream. In response, the access point commences transmitting a response frame to the mobile station, and including a buffer status indication of the second traffic stream. The response frame indicating the buffer status of the second traffic stream may be the last of a series of response frames, or it may be the only response frame if there is no data buffered for the first traffic stream. The invention allows the mobile station to make decisions regarding data retrieval and power save state, and if, for example, the access point indicate a large amount of data is buffered, the mobile station may commence transitioning from a power save state to an active state, whereupon the access point will typically transmit all the data buffered at the access point to the mobile station.

Furthermore, it is contemplated in an alternative embodiment that the proposed mechanism may be used to communicate the number of additional octets the QoS AP (QAP) has queued up in its buffers for a non-AP QoS station (QSTA) in Active mode. Such a mechanism might be used, for example, by a non-AP QSTA to identify a good opportunity to transition from active mode into power save mode, such as after the AP has delivered all pending frames associated with a particular station. Another potential application would be to allow the non-AP QSTA to optimize flow control and resource reservations for variable rate adaptive applications.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. A method for indicating a buffer status of a buffer reserved for a mobile station at an access point, comprising:
receiving, at the access point from the mobile station, a trigger frame, the trigger frame initiating a present service period and including a first traffic stream identifier associated with a first traffic stream, the present service period for transmitting data of the first traffic stream buffered at the access point to the mobile station;
in response to receiving the trigger frame from the mobile station, transmitting a response frame including the first traffic stream identifier and a second traffic stream identifier of a second traffic stream associated with the mobile station, and including a buffer status of the second traffic stream.

2. A method for indicating a buffer status as defined in claim 1, wherein transmitting the response frame includes indicating a present size of the buffer of the second traffic stream.

3. A method for indicating a buffer status as defined in claim 1, wherein transmitting the response frame comprises transmitting an End Of Service Period frame indicating the buffer of the first traffic stream is empty.

4. A method for indicating a buffer status as defined in claim 1, wherein transmitting the response frame comprises transmitting at least one data frame for the first traffic stream.

5. A method for indicating a buffer status as defined in claim 1, wherein the first traffic stream is a voice stream.

6. A method for indicating a buffer status as defined in claim 1, wherein transmitting the response frame includes indicating a priority level of the second traffic stream.

7. A method for receiving an indication of a buffer status of a buffer reserved for a mobile station at an access point, comprising:
transmitting, from the mobile station to the access point, a trigger frame, the trigger frame initiating a present service period and including a first traffic stream identifier associated with a first traffic stream, the present service period for transmitting data of the first traffic stream buffered at the access point to the mobile station;
in response to transmitting the trigger frame from the mobile station, receiving a response frame including the first traffic stream identifier and a second traffic stream identifier of a second traffic stream associated with the mobile station, and including a buffer status of the second traffic stream.

8. A method for indicating a buffer status as defined in claim 7, wherein receiving the response frame includes receiving a present size of the buffer of the second traffic stream.

9. A method for indicating a buffer status as defined in claim 7, wherein receiving the response frame comprises receiving an End Of Service Period frame indicating the buffer of the first traffic stream is empty.

10. A method for indicating a buffer status as defined in claim 7, wherein receiving the response frame comprises receiving at least one data frame for the first traffic stream.

11. A method for indicating a buffer status as defined in claim 7, wherein the first traffic stream is a voice stream.

12. A method for indicating a buffer status as defined in claim 7, wherein receiving the response frame includes receiving an indication of a priority level of the second traffic stream.

13. A method for indicating a buffer status as defined in claim 7, further comprising, in response to receiving the response frame at the mobile station, transitioning the mobile station from a power save state to an active state.

14. A method for transacting data in a wireless local area network (WLAN) between an access point and a mobile station associated with the access point, comprising:
establishing a first traffic stream and a second traffic stream at the access point for the mobile station;
placing the mobile station in a power save state, including indicating to the access point that the mobile station is in the power save state;
buffering data received at the access point destined for the mobile station;
waking up the mobile station;
after waking up the mobile station, transmitting a trigger frame to the access point, including a first traffic stream identifier which identifies the first traffic stream;
transmitting a response frame to the mobile station, and including a buffer status indication of the second traffic stream.

15. A method for transacting data in a WLAN as defined in claim 14, further comprising, in response to receiving the buffer status of the second traffic stream, transitioning the mobile station from a power save state to an active state.

16. A method for transacting data in a WLAN as defined in claim 14, wherein receiving the response frame includes receiving a present size of the buffer of the second traffic stream.

17. A method for transacting data in a WLAN as defined in claim 14, wherein receiving the response frame comprises receiving an End Of Service Period frame indicating the buffer of the first traffic stream is empty.

18. A method for transacting data in a WLAN as defined in claim 14, wherein receiving the response frame comprises receiving at least one data frame for the first traffic stream.

19. A method for transacting data in a WLAN as defined in claim 14, wherein the first traffic stream is a voice stream.

20. A method for transacting data in a WLAN as defined in claim 14, wherein receiving the response frame includes receiving an indication of a priority level of the second traffic stream.
